(19) United States
(12) Patent Application Publication
(10) Pub. No.: US 2026/0170285 A1
(43) Pub. Date: Jun. 18, 2026

(54) PRINTING APPARATUS, PRINTING METHOD, AND NON-TRANSITORY COMPUTER-READABLE RECORDING MEDIUM STORING PRINTING PROGRAM FOR PRINTING APPARATUS

(71) Applicant: Konica Minolta, Inc., Tokyo (JP)

(72) Inventor: Hiroki HIDAKA, Tokyo (JP)

(21) Appl. No.: 19/422,606

(22) Filed: Dec. 17, 2025

(30) Foreign Application Priority Data
Dec. 18, 2024 (JP) 2024-221594

(51) Int. Cl. G06K 15/02; G03G 15/00; G06F 3/12

(52) U.S. Cl. CPC G06K 15/186; G06F 3/1208; G06F 3/1215; G06F 3/1248; G06F 3/1256; G06K 15/1843; G03G 15/6517

(57) ABSTRACT

The printing apparatus according to the present disclosure includes a controller that generates bitmap data by performing rasterization processing on PDL data to be printed when a print job is executed. The controller performs, before executing the print job, the rasterization processing on a provisional basis on the PDL data at a second resolution lower than a first resolution used in actual printing, and predicts a rasterization time during the actual printing based on a processing time taken in the rasterization processing on the provisional basis, a magnification relationship between the first resolution and the second resolution, and configuration information of each object existing in the PDL data.

### CROSS REFERENCE TO RELATED APPLICATIONS

The present invention claims priority under 35 U.S.C. § 119 to Japanese Patent Application No. 2024-221594, filed on Dec. 18, 2024, is incorporated herein by reference in its entirety.

### BACKGROUND

### Technological Field

The present disclosure relates to a printing apparatus, a printing method, and a non-transitory computer-readable recording medium storing a printing program for a printing apparatus.

### Description of Related Art

In the related art, in printing apparatuses, page description language (PDL) data described in a page description language transferred from a host computer is rasterized to generate bitmap data. Then, in the printing apparatuses, the bitmap data is output to a printing section to perform printing. See, for example, Japanese Patent Application Laid-Open No. 2012-119955.

Incidentally, the processing time required for the rasterization processing varies depending on the number of pages of the entire document to be printed, the document size, the number of objects in each page, and the occupancy of a CPU or processor core related to the processing. For this reason, the processing time may be as short as several seconds, or may take several hours in some cases, which affects the entire printing processes. Note that, hereinafter, the processing time required for the rasterization processing will be referred to as the “rasterization time”.

When the rasterization time can be predicted in advance, it is possible to take the order of printing processes into consideration or use the rasterization time as an index of a waiting time for continuous printing in a label machine, whereby it is possible to achieve an improved production efficiency.

From such a background, various methods for predicting the rasterization time have been taken into consideration. For example, in recent years, a method of performing rasterization processing of PDL data at a low resolution before actual rasterization processing and predicting an actual rasterization time based on the rasterization time required for performing the rasterization processing of the PDL data at the low resolution, or the like, has also been taken into consideration. However, in the related art, it is difficult to accurately predict the rasterization time, and a customer cannot assemble printing processes under the present circumstances.

### SUMMARY

The present invention has been made in view of the above-mentioned problems. That is, an object of the present invention is to provide a printing apparatus, a printing method, and a printing program each capable of enabling highly accurate prediction of the processing time of rasterization processing.

To achieve at least one of the abovementioned objects, according to an aspect of the present invention, the printing apparatus reflecting one aspect of the present invention is a printing apparatus including a hardware processor that functions as a controller that generates bitmap data by performing rasterization processing on PDL data to be printed when a print job is executed.

The controller performs, before executing the print job, the rasterization processing on a provisional basis on the PDL data at a second resolution lower than a first resolution used in actual printing, and
the controller predicts a rasterization time during the actual printing based on a processing time taken in the rasterization processing on the provisional basis, a magnification relationship between the first resolution and the second resolution, and configuration information of each object existing in the PDL data.

In addition, the printing method reflecting another aspect of the present invention is a printing method by a printing apparatus that generates bitmap data by performing rasterization processing on PDL data to be printed and executes printing based on the bitmap data when a print job is executed, and the printing method includes:
performing, before executing the print job, the rasterization processing on a provisional basis on the PDL data at a second resolution lower than a first resolution at which actual print processing is executed, and
predicting a rasterization time during actual printing based on a processing time taken in the rasterization processing on the provisional basis, a magnification relationship between the first resolution and the second resolution, and configuration information of each object existing in the PDL data.

In addition, the printing program reflecting yet another aspect of the present invention is a non-transitory computer-readable recording medium storing a printing program for a printing apparatus that generates bitmap data by performing rasterization processing on PDL data to be printed and executes printing based on the bitmap data when a print job is executed, and the printing program causes the printing apparatus to execute:
performing, before executing the print job, the rasterization processing on a provisional basis on the PDL data at a second resolution lower than a first resolution at which actual print processing is executed, and
predicting a rasterization time during actual printing based on a processing time taken in the rasterization processing on the provisional basis, a magnification relationship between the first resolution and the second resolution, and configuration information of each object existing in the PDL data.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating the configuration of a printing system according to Embodiment 1;

FIG. 2 is a diagram illustrating the configuration of a printing apparatus according to Embodiment 1;

FIG. 3 is a diagram simply illustrating a flow of rasterization processing at the time of printing in the printing apparatus according to Embodiment 1;

FIG. 4 is a diagram schematically illustrating rasterization time prediction processing performed by a controller of the printing apparatus according to Embodiment 1;

FIG. 5 is a diagram illustrating examples of a correction magnification table which is referred to by the controller of the printing apparatus according to Embodiment 1 when the controller performs the rasterization time prediction processing;

FIG. 6 is a diagram schematically illustrating calculation processing of a predicted value of a rasterization time (Example 1);

FIG. 7 is a diagram schematically illustrating calculation processing of the predicted value of the rasterization time (Example 2);

FIG. 8 is a diagram illustrating the configurations of the correction magnification tables (Example 2);

FIG. 9 is a diagram schematically illustrating provisional rasterization processing in the controller of the printing apparatus according to Embodiment 2;

FIG. 10 is a diagram illustrating an example of a data table for setting the resolution used for the provisional rasterization processing by the controller of the printing apparatus according to Embodiment 2;

FIG. 11 is a diagram illustrating an example of an operation flow of the controller of the printing apparatus according to Embodiment 2;

FIG. 12 is a diagram illustrating a problem that occurs in a case where rasterization processing of PDL data and print processing of images, which have been converted into bitmap data by the rasterization processing, are simultaneously executed in parallel in a printing apparatus according to the related art; and

FIG. 13 is a diagram illustrating an example of printing plan generation processing performed by the controller of the printing apparatus according to Embodiment 3.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments to which the present invention has been applied will be described in detail with reference to the accompanying drawings. In the present specification and drawings, elements having substantially the same function or configurations will be denoted by the same reference signs, and redundant description thereof will be omitted.

### <Configuration of Printing System>

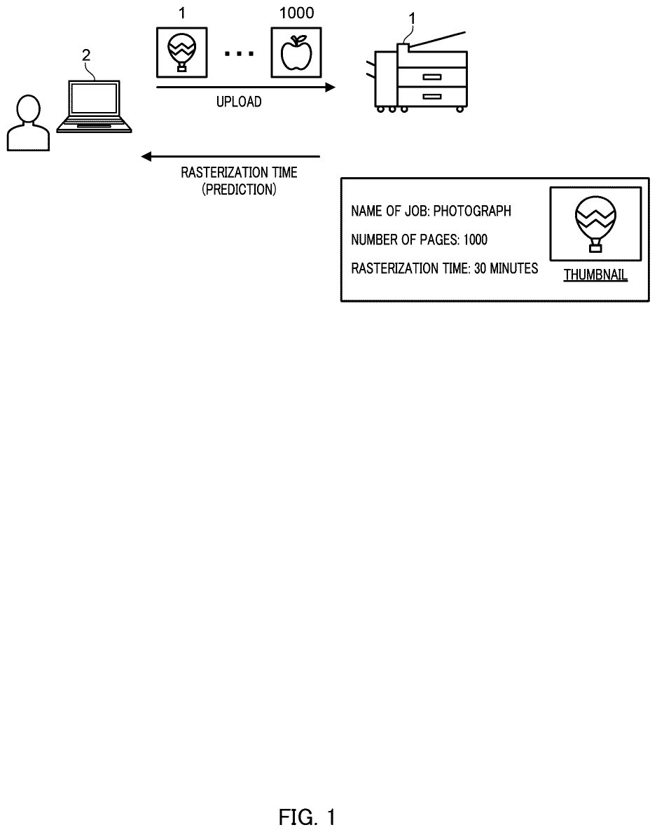

First, the configuration of a printing system (hereinafter referred to as “printing system A”) according to an embodiment of the present invention will be described with reference to FIG. 1.

FIG. 1 is a diagram illustrating the configuration of the printing system A.

The printing system A is configured to include, for example, a printing apparatus 1 and an external apparatus 2. The respective apparatuses of the printing apparatus 1 and the external apparatus 2 are connected to each other via a network such as a LAN so as to be capable of performing data communication.

The printing apparatus 1 is a so-called multi-function peripheral (MFP) having a copy function, an image reading function, and a printer function. As the printing apparatus 1, for example, a tandem-type image processing apparatus which includes a photosensitive drum for each color of CMYK and performs printing by conveying a sheet at the same time as image formation on the photosensitive drum can be applied. In addition, the printing apparatus 1 may be an image processing apparatus that includes only a single-color photosensitive drum and forms a monochrome image. The printing apparatus 1 forms an image on a sheet based on print job data or the like transmitted from the external apparatus 2.

The external apparatus 2 is, for example, a host computer (hereinafter referred to as the host PC), and has a function of transmitting print job data to the printing apparatus 1. A printer driver is installed in the external apparatus 2. The external apparatus 2 uses the function of the printer driver to generate print job data including data of printing conditions that is applied at the time of image formation, or the like, and transmits the print job data to the printing apparatus 1.

The print job data is, for example, PDL data of a page description language such as PS, PCL, PDF, or XPS (hereinafter referred to as PDL data).

Note that, the printing apparatus 1 according to the present embodiment is configured to be capable of predicting the processing time required for rasterizing PDL data in advance by performing rasterization processing on a provisional basis on the PDL data. FIG. 1 illustrates an aspect in which the printing apparatus 1 transmits back the total time of the processing time required for rasterizing PDL data for all pages included in a document of received print job data as the prediction result of the rasterization time to the external apparatus 2.

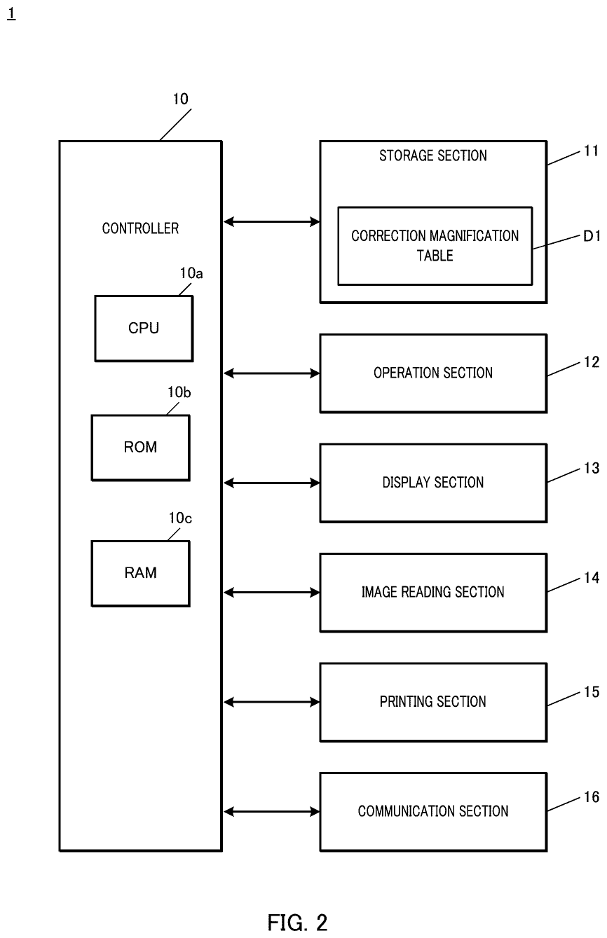

FIG. 2 is a diagram illustrating the configuration of the printing apparatus 1.

The printing apparatus 1 includes a controller 10, a storage section 11, an operation section 12, a display section 13, an image reading section 14, a printing section 15, and a communication section 16, which are electrically connected to each other via a bus.

The controller 10 is, for example, a microcomputer including a CPU 10a, a ROM 10b, a RAM 10c, and the like. The controller 10 reads a program according to the processing content from the ROM 10b, develops the program in the RAM 10c, and performs centralized control of the operation of the printing section 15 or the like in cooperation with the developed program. At this time, various types of data stored in the storage section 11 are referred to. The storage section 11 is configured by, for example, a non-volatile semiconductor memory (so-called flash memory) and/or a hard disk drive.

The controller 10 transmits and receives various data to and from the external apparatus 2 connected to a network such as a LAN or a WAN via the communication section 16. The controller 10 receives, for example, print job data transmitted from the external apparatus 2, and causes printing to be executed on a recording medium based on the print job data.

At the time of image formation processing, the controller 10 analyzes print job data (PDL data) received from the external apparatus 2, and generates data in an intermediate language (display list) format (hereinafter also referred to as a display list). Then, rasterization processing is performed based on the display list, and data in a bitmap format (hereinafter also referred to as bitmap data) as print data is generated. Then, the generated bitmap data is output to the printing section 15.

The storage section 11 stores a lookup table (LUT) used for image processing, a correction magnification table D1 to be referred to by the controller 10 when the controller 10 predicts the rasterization time, and the like.

The operation section 12 includes various keys such as numeric keys, a start key, and a reset key, and outputs a pressing signal of a pressed key to the controller 10. In addition, the operation section 12 includes a touch screen formed integrally with the display section 13, detects a position on the touch screen, on which a user's fingertip, a touch pen, or the like abuts, and outputs a position signal to the controller 10.

The display section 13 is constituted by an LCD or the like provided so as to be covered by the touch screen, and displays various setting screens for inputting various setting conditions, various processing results, and the like according to display signals input from the controller 10.

The image reading section 14 is a so-called scanner that reads a document image to generate image data, and includes a platen glass, on which a document is placed, and a scanning optical system that scans the document image on the platen glass to form an image of the document image on a CCD image sensor. The image reading section 14 performs A/D conversion on an image signal generated based on the document image read by the CCD image sensor to generate an image signal.

The printing section 15 is a function section including constituent elements necessary for forming an image by utilizing an imaging process such as an electrophotographic method, an electrostatic recording method, or a thermal transfer method. For example, the printing section 15 includes an exposure unit, a developing unit, an image forming unit including a photosensitive drum and the like, a fixing unit, a sheet feed unit, a conveyance unit, a sheet ejection unit, a driving control apparatus, and the like. According to an instruction of the controller 10, the printing section 15 forms an image on a sheet supplied from the sheet feed unit based on image data generated by the image reading section 14, print job data received by the communication section 16, or the like, and conveys the sheet to the sheet ejection unit.

The communication section 16 includes a LAN adapter, a router, a TA, and the like, and transmits and receives data to and from an external device such as the external apparatus 2 connected via a communication network 3. For example, the communication section 16 receives PLD data from the external apparatus 2.

### <Basic Processing of Rasterization>

Next, basic processing of rasterization by the controller 10 will be described.

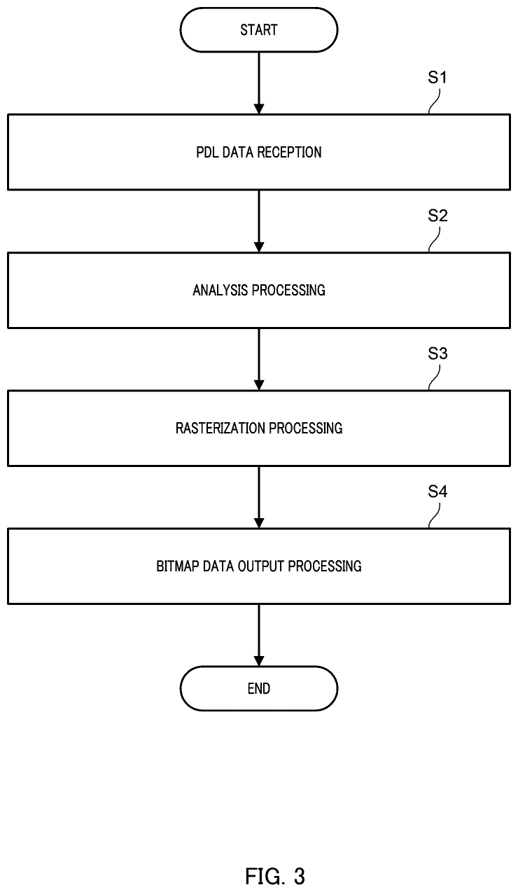

FIG. 3 is a diagram simply illustrating a flow of rasterization processing at the time of printing.

The controller 10 acquires PDL data, which has been transmitted from the external apparatus 2, via the communication section 16, and causes the acquired PDL data to be temporarily stored in the RAM 10c (step S1).

The controller 10 reads the PDL data from the RAM 10c and executes language analysis processing (step S2). In the language analysis processing, the read PDL data for one page is divided into bands of a plurality of lines, and a display list in a language format between the PDL data and the bitmap data is generated in units of the divided bands. The controller 10 causes the generated display list to be temporarily stored in the RAM 10c.

The display list is data generated according to characteristics of objects (text data, graphics data, image data, and the like) included in the PDL data. Examples of the display list of text data or graphic data include data in a vector format, and examples of the display list of image data include data in an image format.

At a time when the display list for one page has been completed, the controller 10 reads the display list from the RAM 10c and executes rendering processing based on the read display list (step S3). In the rendering processing, pieces of bitmap data divided in units of bands are generated and sequentially saved in the RAM 10c. At this time, for example, the controller 10 converts pieces of object data of objects stored in the display list into pieces of bitmap data one by one in units of bands.

When the bitmap image for one page has been completed, the controller 10 reads the bitmap data from the RAM 10c, executes an output of the bitmap data to the printing section 15, and activates the printing section 15 to cause the printing section 15 to execute print processing (step S4). Then, at the printing section 15, an image is formed on a sheet based on the input bitmap data.

Note that, the processing (language analysis processing and rendering processing) of steps S2 and S3 illustrated in FIG. 3 is generally divided in units of bands or in units of pages by a plurality of CPU cores and is processed in parallel by multitasking.

### <Predication Processing of Rasterization Time>

The controller 10 according to the present embodiment has a function of performing the following first to fourth processes on PDL data received from the external apparatus 2 and predicting the rasterization time taken in the actual rasterization processing in advance.

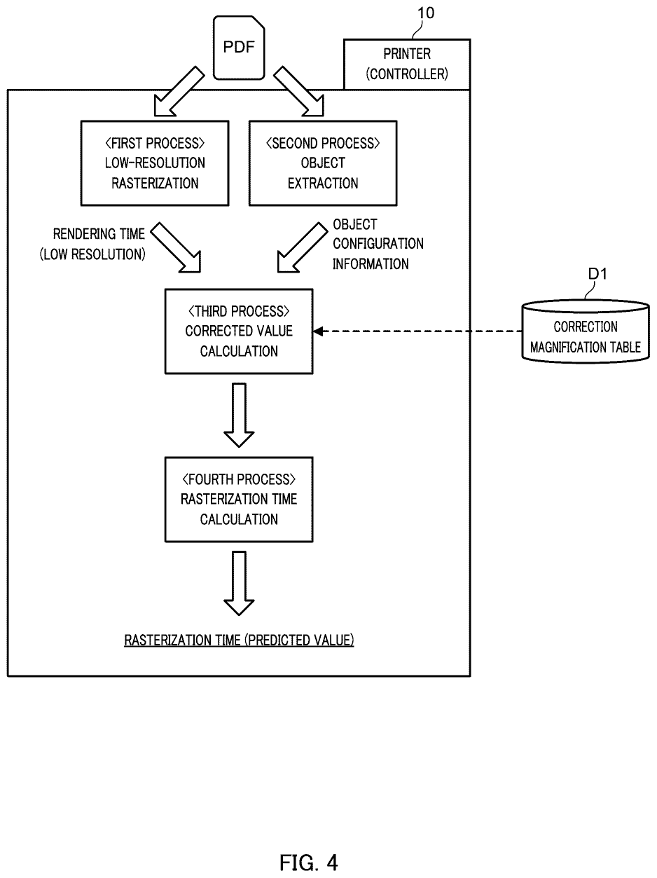

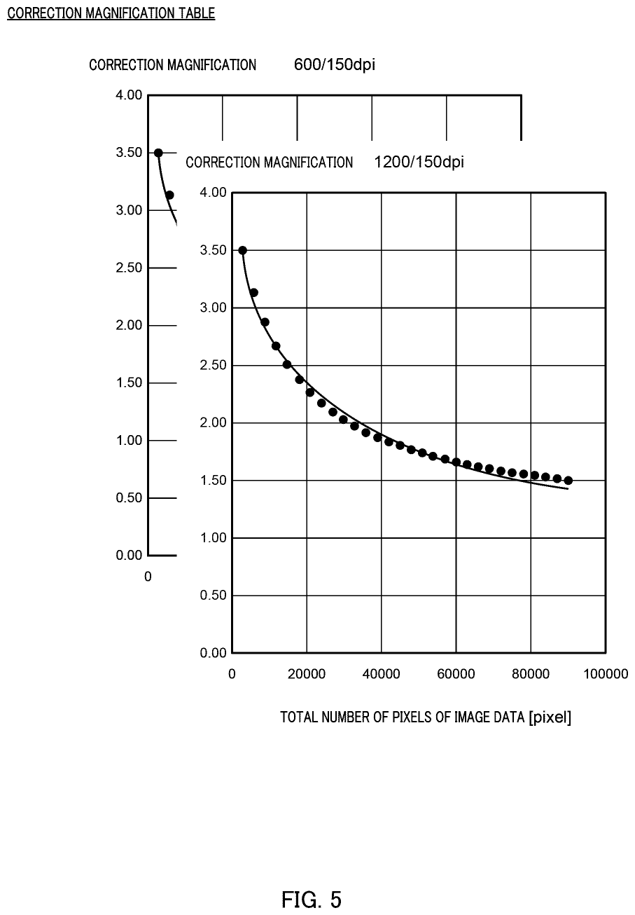

FIG. 4 is a diagram schematically illustrating rasterization time prediction processing performed by the controller 10. FIG. 5 is a diagram illustrating examples of the correction magnification table D1 which is referred to by the controller 10 when the controller 10 performs the rasterization time prediction processing.

Note that, the rasterization time taken in the actual rasterization processing is the sum of the time taken in the language analysis processing and the time taken in the rendering processing. However, the language analysis time is shorter than the rendering time. In addition, the language analysis processing is generally executed in parallel with the rendering processing. For this reason, the language analysis time is ignored here, and the rendering time is handled as the rasterization time.

### [First Process]

In the first process, the controller 10 performs rasterization processing on a provisional basis (hereinafter referred to as “provisional rasterization processing”) on the received PDL data at a resolution lower than the resolution at the time of the actual rasterization processing. The controller 10 typically performs this provisional rasterization processing in units of pages. Here, the resolution at the time of the actual rasterization processing (hereinafter referred to as the “first resolution”) is, for example, 1200 dpi. In addition, the resolution at the time of the provisional rasterization processing (hereinafter referred to as the “second resolution”) is, for example, 150 dpi. However, the values of the first resolution and the second resolution are appropriately variable according to the content of the print processing.

The processing content itself of the provisional rasterization processing is the same as normal rasterization processing, where the language analysis processing and the rendering processing are sequentially executed on the PDL data. At this time, controller 10 measures the processing time of the rendering processing. Then, the controller 10 stores the time taken in the rendering processing (that is, the rasterization time) in the RAM 10c.

Note that, in a case where the document to be printed includes a plurality of pages, the controller 10 performs the provisional rasterization processing on the PDL data of each page, measures the rasterization time, and stores, for each page, the rasterization time taken in the provisional rasterization processing in the RAM 10c.

Note that, the appropriate resolution when performing the provisional rasterization processing (that is, the second resolution) in the first process may be set based on the configuration(s) of an object(s) existing in the PDL data (see Embodiment 2 to be described later).

### [Second Process]

In the second process, the controller 10 extracts configuration information of each object included in PDL data from the PDL data. At this time, the controller 10 typically extracts the configuration information of the object(s) in units of page. Note that, since the PDL data usually has a data configuration in units of objects, no special processing is required for the processing itself of extracting the configuration information of an object(s) therefrom.

Here, examples of the configuration of objects include the types of objects existing in a page and the number of objects existing in the page. Examples of the types of objects include image data (here, including photograph data and embedded illustration data; the same applies hereinafter), graphic data, and text data.

In the second process, the controller 10 desirably extracts, in particular, the number of pixels of each image data existing in a page and extracts the total number of pixels thereof. As will be described later, this is because the total number of pixels of image data existing in a page particularly has a large influence on the rasterization time. However, from the viewpoint of improving the prediction accuracy of the rasterization time, the controller 10 may also extract the total number of graphics defined by graphics data existing in a page and the total number of texts defined by text data existing in a page.

Note that, in a case where the document to be printed includes a plurality of pages, the controller 10 extracts the configuration information of an object(s) from the PDL data of each page, and stores the configuration information in the RAM 10c for each page.

### [Third Process]

In the third process, the controller 10 refers to the correction magnification table D1 stored in the storage section 11 in advance and acquires the correction magnification for converting the processing time taken in the provisional rasterization processing in the first process into the actual rasterization time (hereinafter, the above correction magnification will be abbreviated to the correction magnification).

The correction magnification table D1 is data for defining, for example, the correction magnification by using the magnification relationship between the first resolution and the second resolution and the configuration of an object(s) as input variables. In FIG. 5, as examples of the correction magnification table D1, 150 dpi (the second resolution)/1200 dpi (the first resolution) and 150 dpi (the second resolution)/600 dpi (the first resolution) are prepared as the magnification relationship between the first resolution and the second resolution. The correction magnification table D1 defines the correction magnifications based on the total number of pixels of the image data of the objects present in one page of PDL data for each magnification relationship.

Note that, the correction magnification table D1 is obtained by, for example, prior verification (experiment or simulation). However, since it is difficult to acquire experimental date for all the preconditions, the correction magnification table D1 may be prepared in the form of a regression equation or the like that allows calculation of output values according to input explanatory variables (for example, the total number of pixels of image data) based on experimental data.

Generally, it is known that in a case where the resolution at the time of performing rasterization processing is high, the number of bands at the time of dividing PDL data for one page into a plurality of lines also increases, and thus, the rasterization time becomes longer correspondingly. For this reason, when the processing time taken in the provisional rasterization processing is converted into the actual rasterization time, correction processing in response to the magnification relationship between the first resolution and the second resolution is required.

However, according to the findings of the inventor of the present invention, in a case where rasterization processing is performed at a low resolution, the configuration of an object is more likely to be omitted than in the actual configuration, and the correction magnification that is required depending on the configuration of the object is more likely to fluctuate. That is, in the correction processing for correcting the processing time taken in the provisional rasterization processing based on only the resolution at the time of the provisional rasterization processing as discussed in the related art, sufficient accuracy cannot be expected in the calculated predicted value of the rasterization time.

From such a viewpoint, in the correction magnification table D1 according to the present embodiment, the correction magnification using the magnification relationship between the first resolution and the second resolution and the configuration of an object(s) as input variables is defined.

According to the results of intensive studies by the inventor of the present invention, the rendering time (that is, the rasterization time) depends on, in particular, the total number of pixels of image data existing in a page. That is, the influence of the number of images of image data, text data, and graphic data is small in comparison with the total number of pixels of the image data. From such a viewpoint, in the correction magnification table D1 according to the present embodiment, the total number of pixels of image data existing in a page is as an input variable as the configuration of an object(s).

Note that, the plots of the correction magnifications illustrated in FIG. 5 are set based on the rasterization time obtained by actually performing prior verification for each condition of the input variables. In FIG. 5, as the reason why the correction magnification decreases as the total number of pixels of image data increases, it is presumed that the provisional rasterization processing time itself obtained when the rasterization processing is performed at a low resolution increases as the total number of pixels of the image data increases.

However, the correction magnification table D1 in which, in addition to the total number of pixels of image data existing in a page, the total number of graphics defined by graphic data existing in the page, the total number of texts defined by text data existing in the page, and the like are also used as input variables may be configured. Thus, it is possible to further improve the prediction accuracy of the rasterization time.

Note that, in a case where the document to be printed includes a plurality of pages, the controller 10 acquires the correction magnification to be applied to each page based on the configuration of an object(s) of PDL data of each page and stores the acquired correction magnification in the RAM 10c.

### [Fourth Process]

In the fourth process, the controller 10 corrects the processing time taken in the provisional rasterization processing based on the correction magnification obtained in the third process. The controller 10 performs such correction processing by multiplying the processing time taken in the provisional rasterization process obtained in the first process by the correction magnification obtained in the third process, for example.

Note that, in a case where the document to be printed includes a plurality of pages, the controller 10 corrects the rasterization time (the processing time taken in the provisional rasterization processing) obtained in the first process based on the correction magnification obtained in the third process for each page.

The controller 10 stores the obtained predicted value of the rasterization time in the RAM 10c and transmits data related to the predicted value of the rasterization time to the external apparatus 2. At this time, for example, as the prediction result of the rasterization time, the controller 10 may transmit to the external apparatus 2, the total time of the processing times required for rasterizing the PDL data for all the pages included in the document of the received print job data as in the following equation (1).

[1]

Predicted value of rasterization time of print job data=(correction magnification depending on provisional rasterization time×object configuration) . . . the total for all pages (Equation (1))

Note that, the controller 10 may further perform the following adjustment from the viewpoint of enhancing the accuracy of the predicted value of the rasterization time.

In a case where image correction setting(s) (for example, color conversion, color bar, and/or outline processing) has/have been performed in the job settings of a print job, the controller 10 may add an adjustment margin to the predicted value of the rasterization time based on the content(s) of the image correction setting(s). For example, in a case where a monochrome setting has been made in the job settings of a print job, the actual rasterization time is shorter than that at the time of color output. For this reason, the controller 10 may adjust the predicted value of the rasterization time calculated as described above, for example, by multiplying the predicted value by a predetermined factor according to the content(s) of the image correction setting(s).

In addition, the controller 10 may calculate the predicted value of the rasterization time in consideration of the language analysis time in addition to the rendering time. However, since the language analysis processing is generally executed in parallel with the rendering processing, it is sufficient in this case to take only the language analysis time for the first page into consideration. For example, the controller 10 may add the language analysis time for the first page to the predicted value of the rasterization time calculated by the above equation (1) to obtain the predicted value of the rasterization time of the print job data.

In addition, the controller 10 may calculate the predicted value of the rasterization time in consideration of the document size defined by the PDL data. This is because the number of divided bands in the rasterization processing varies depending on the document size, and the rasterization time also varies correspondingly. In this case, for example, it is desirable to prepare the correction magnification table D1 for each document size.

In addition, the controller 10 may calculate the predicted value of the rasterization time in consideration of the data format of the PDL data. This is because the rasterization time may vary depending on which data format the PDL data is described in among the PCL format, the PDF format, the XPS format, or the like. In this case, for example, it is desirable to prepare the correction magnification table D1 for each data format of the PDL data.

Next, specific examples of the calculation processing function of the predicted value of the rasterization time will be described.

### Example 1

In the present example, an aspect in which the predicted value of the rasterization time for a document of one page (PDL data) constituted by a plurality of pieces of image data is calculated will be described.

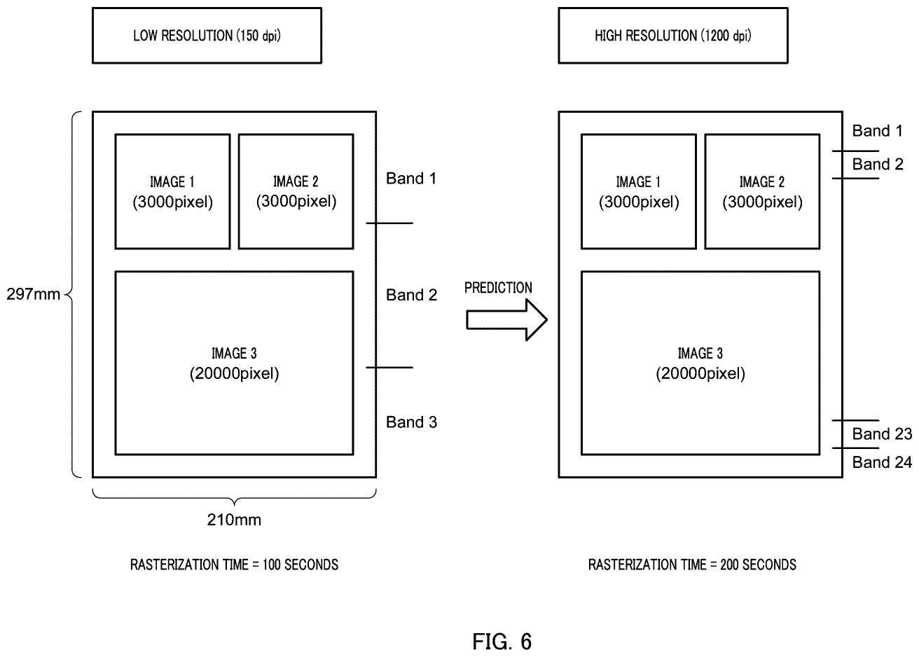

FIG. 6 is a diagram schematically illustrating calculation processing of the predicted value of the rasterization time in Example 1. Note that, in the present example, it is assumed that the correction magnification tables D1 illustrated in FIG. 5 are used.

First, the controller 10 performs the provisional rasterization processing on the PDL received from the external apparatus 2 at the second resolution (150 dpi in this case) lower than the first resolution (1200 dpi in this case) used at the time of actual printing. Then, the controller 10 measures the rasterization time taken at this time (100 seconds in this case) and stores the rasterization time in the RAM 10c (the first process). Note that, at this time, the controller 10 can acquire the document size and the number of bands (the number of bands in the provisional rasterization processing in this case). Here, the document size was 210×297 mm, and the number of bands in the provisional rasterization processing was three.

Next, the controller 10 acquires configuration information of an object(s) from the PDL data received from the external apparatus 2 (the second process). In the case of the present example, there were three images, and the total number of pixels of all the images was 26000 pixels (3000+3000+20000).

Next, the controller 10 refers to the correction magnification table D1, and acquires the correction magnification for correcting the predicted value of the rasterization time based on the configuration information of each object in the PDL data and the magnification relationship between the first resolution and the second resolution (the third process). In the present example, the controller 10 refers to the correction magnification tables D1 illustrated in FIG. 5 and acquires 2.0 as the correction magnification.

Next, the controller 10 corrects the rasterization time at the low resolution obtained in the first process based on the correction magnification obtained in the third process (the fourth process). In the case of the present example, the predicted value of the rasterization time is calculated as 200 seconds based on the processing time taken in the provisional rasterization processing of 100 seconds×the correction magnification of 2.0.

### Example 2

In the present example, an aspect in which the predicted value of the rasterization time for a document of one page (PDL data) constituted by a plurality of pieces of image data and a plurality of pieces of text data is calculated will be described.

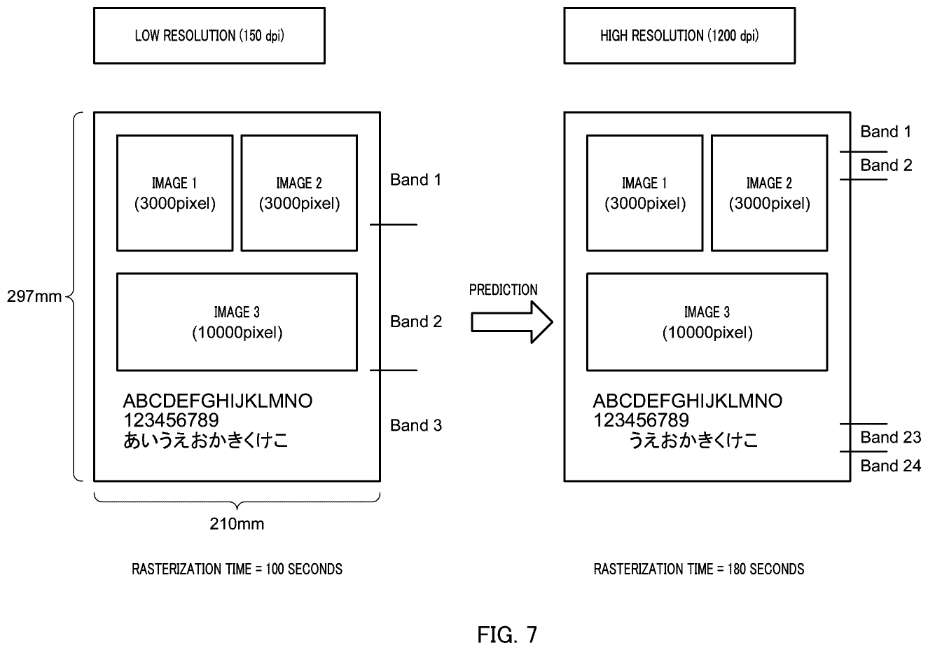

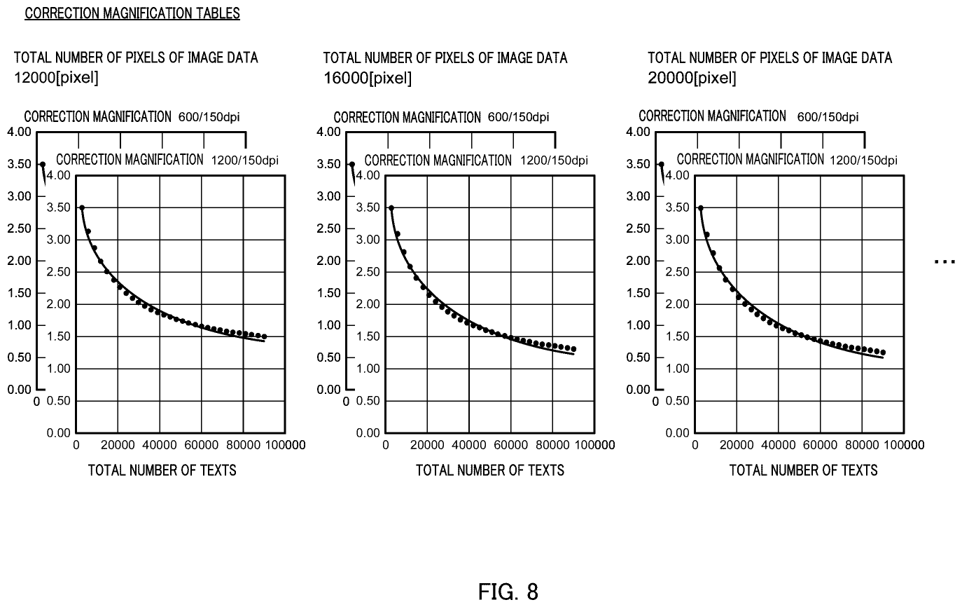

FIG. 7 is a diagram schematically illustrating calculation processing of the predicted value of the rasterization time according to the present example. FIG. 8 is a diagram illustrating the configurations of the correction magnification tables D1 referred to in the present example. Note that, in the correction magnification tables D1 referred to in the present example, the correction magnification is defined by using the magnification relationship between the first resolution and the second resolution, the total number of pixels of image data, and the total number of texts defined by text data as input variables. For the sake of description, FIG. 8 illustrates only the tables when the total number of pixels of image data is 12000 pixels, the total number of pixels of image data is 16000 pixels, and the total number of pixels of image data is 20000 pixels.

The contents of the first process are the same as those in Example 1. Here, it is assumed that the rasterization time obtained in the first process is 100 seconds. Note that, the rasterization time obtained in the first process of the present example is identical to the rasterization time obtained in the first process of Example 1. This is because the load of the rasterization processing of the text data is small and the effect thereof on the rasterization processing time is small. In addition, this is because a difference in the rasterization time depending on the configuration of an object(s) is unlikely to occur in the provisional rasterization processing performed at the second resolution (150 dpi in this case) which is a low resolution.

In the subsequent second process, the controller 10 acquires the configuration information of each object included in the PDL data. At this time, it was analyzed that there were three images, the total number of pixels was 16000 pixels in total, and the number of texts was 50000.

In the subsequent third process, the controller 10 acquires the correction magnification corresponding to these input variables (the magnification relationship between the first resolution and the second resolution, the total number of pixels of image data, and the number of texts of image data) from the correction magnification table D1. Here, the controller 10 obtained a correction magnification of 1.8 from the correction magnification table D1.

In the subsequent fourth process, the controller 10 multiplies the processing time of 100 seconds taken in the provisional rasterization processing by the correction magnification of 1.8. Thus, it can be predicted that the actual rasterization time is 180 seconds (=100 seconds×1.8).

### [Effects]

As described above, in the present embodiment, a printing apparatus has been disclosed which includes a controller that generates bitmap data by performing rasterization processing on PDL data to be printed when a print job is executed.

The controller performs, before executing the print job, the rasterization processing on a provisional basis on the PDL data at a second resolution lower than a first resolution used in actual printing, and
the controller predicts a rasterization time during the actual printing based on a processing time taken in the rasterization processing on the provisional basis, a magnification relationship between the first resolution and the second resolution, and configuration information of each object existing in the PDL data.

According to the printing apparatus according to the present embodiment, it is possible to predict the processing time of the rasterization processing with high accuracy.

### Embodiment 2

In the above-described embodiment, the resolution at the time of the provisional rasterization processing (that is, the second resolution) is set to the fixed value (150 dpi). However, in the present embodiment, the resolution is variably set.

Usually, the processing time of the provisional rasterization processing in the first process is shorter as the number of output bands decreases. Since the number of bands depends on the document size and the resolution, it is necessary to lower the resolution in order to accelerate the processing. However, when the resolution is lowered too much, the number of samples of actual values (=the number of samples of the band processing time) decreases, and thus, there is a risk that the reliability of the predicted value of the actual rasterization time will decrease.

Accordingly, in the present embodiment, the controller 10 according to the present embodiment extracts the configuration information of an object(s) existing in the PDL data to be printed before performing the provisional rasterization processing in the first process. Then, the controller 10 sets the resolution at the time of the provisional rasterization processing based on the configuration information of the object(s).

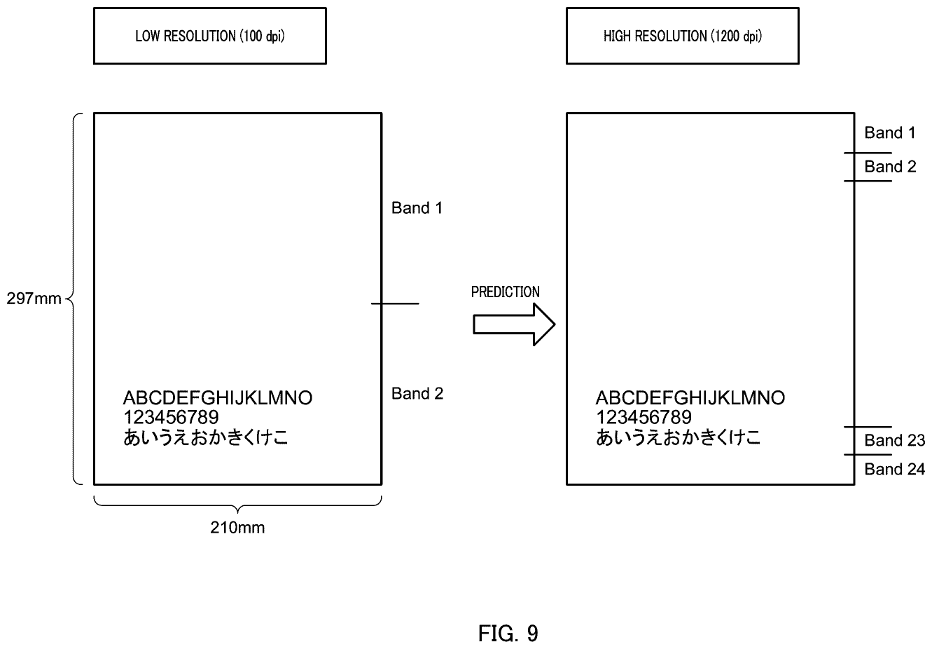

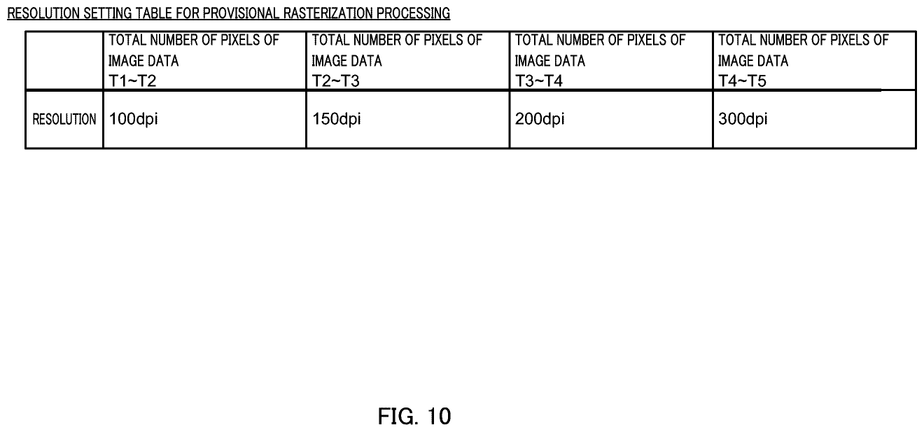

FIG. 9 is a diagram schematically illustrating the provisional rasterization processing in the controller 10 according to the present embodiment. FIG. 10 is a diagram illustrating an example of a data table for setting the resolution used for the provisional rasterization processing.

In the case of FIG. 9, only a small amount of text data (for example, a letter) exists in the document. It is known that such a configuration and such a rasterization time are almost the same as those of a blank sheet. In this case, it is useful to further lower the resolution at the time of the provisional rasterization processing to lower the number of output bands and increase the speed of the processing time.

Accordingly, in the present embodiment, the controller 10 sets the resolution at the time of the provisional rasterization processing in the first process to 100 dpi and lowers the number of bands at the time of the provisional rasterization processing to two.

Note that, conversely, in a case where the object configuration in the PDL data to be printed is complicated and the rasterization time is likely to be affected significantly depending on the object configuration, the controller 10 may increase the resolution to 300 dpi or the like to increase the number of output bands. Thus, it is possible to acquire the predicted value of the actual rasterization time under conditions closer to those in the actual rasterization processing.

From such a viewpoint, the resolution setting data table illustrated in FIG. 10 has a table structure in which the larger the total number of pixels of image data existing in a page, the higher the resolution used for the provisional rasterization processing.

Note that, in the aspect of the present embodiment, the configuration information of an object(s) existing in PDL data to be printed is extracted before the provisional rasterization processing in the first process is performed, and thus, the second process described in the above embodiment may be common to this process.

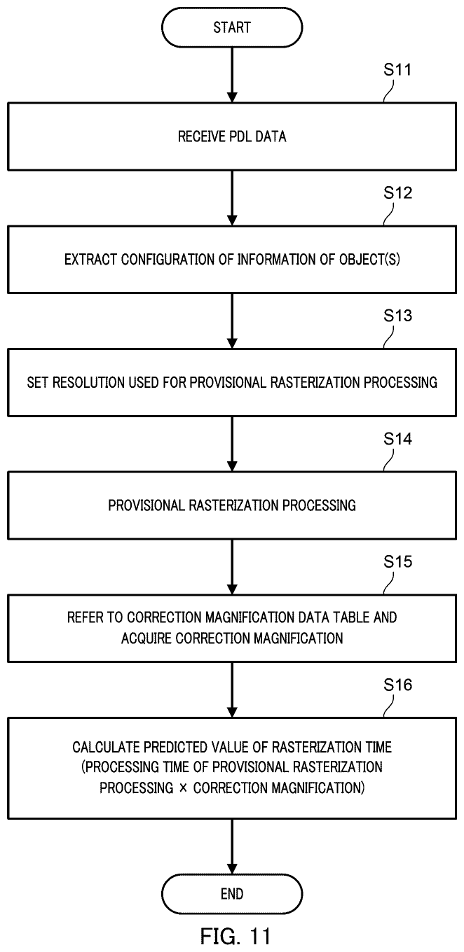

FIG. 11 is a diagram illustrating an example of an operation flow of the controller 10 according to the present embodiment.

First, the controller 10 receives PDL data of a document to be printed from the external apparatus 2 (S11). Next, the controller 10 extracts the configuration information of each object included in the PDL data (S12). Next, the controller 10 refers to the resolution setting data table, and sets the resolution (the second resolution) used for the provisional rasterization processing based on the configuration information of the each object included in the PDL data (S13). Next, the controller 10 performs the provisional rasterization processing at the resolution set in S13, measures the rasterization time at that time, and stores the measured rasterization time in the RAM 10c (S14). Next, the controller 10 refers to the correction magnification table D1 and acquires the correction magnification based on the magnification relationship between the resolution (the first resolution) used at the time of actual printing and the resolution (the second resolution) set in S13 and the configuration information of the object(s) acquired in S12 (S15). Next, the controller 10 calculates the predicted value of the actual rasterization time by multiplying the processing time taken in the provisional rasterization processing by the correction magnification acquired in S15 (S16).

As described above, according to the printing apparatus 1 according to the present embodiment, it is possible to shorten the processing time when calculating the predicted value of the rasterization time taken at the time of actual printing.

### Embodiment 3

In the above-described embodiments, the aspect in which the rasterization time for the entire document to be printed of the print job is predicted based on the predicted value of the rasterization time of the PDL date of each page has been described. In the present embodiment, the controller 10 further calculates, based on the predicted value of the rasterization time of the PDL date of each page, a printing plan when the print job is executed.

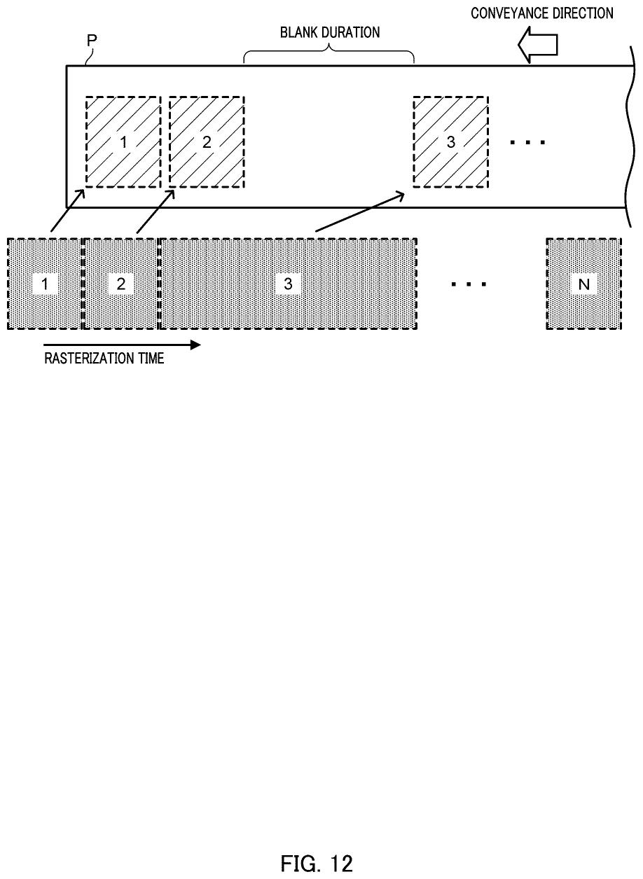

FIG. 12 is a diagram illustrating a problem that occurs in a case where rasterization processing of PDL data and print processing of images, which have been converted into bitmap data by the rasterization processing, are simultaneously executed in parallel in a printing apparatus according to the related art. Here, a problem when a roll printing machine is used as the printing apparatus is described. Note that, in the related art, various methods for simultaneously executing rasterization processing of PDL data and print processing of an image in parallel have been taken into consideration from the viewpoint of efficiency of the entire printing process.

Note that, the upper portion of FIG. 12 illustrates a state in which a document image for the first page, a document image for the second page, a document image for the third page, . . . and a document image for of the N-th page are sequentially printed on roll paper P from the front end side by the roll printing machine. The lower portion of FIG. 12 schematically illustrates the completion times of the rasterization processing for the respective pages together with the conveyance timings of the roll paper P. In such an aspect, processing in which the rasterization of the document image for the first page is followed by the printing of the document image, the rasterization of the document image for the second page is followed by the printing of the document image, and so on is repeated.

The roll printing machine is generally configured by connecting a sheet feed unit, an image forming unit, and a winding unit from the upstream side along the conveyance direction of the roll paper P. Then, the roll paper P is configured to be sequentially fed out from the sheet feed unit, to be subjected to image formation by the image forming unit, and to be wound up by the winding unit. See, for example, Japanese Patent Application Laid-Open No. 2024-015782 for an example of the configuration of the roll printing machine.

In this type of roll printing machine, it is generally difficult to stop the conveyance of the roll paper P in the middle, and it is necessary to sequentially perform the conveyance and the image formation in synchronization with each other. For this reason, in a case where it takes a long time to perform rasterization processing of an arbitrary page (for example, the third page in FIG. 12) of the document and printing of the document image is delayed with respect to the conveyance speed, a blank region is formed on the roll paper P during that time. In many cases, the roll paper P is subsequently subjected to cutting processing in units of pages, and such a blank region could be a serious problem for the user.

In view of such a background, in the related art, when printing is performed by a roll printing machine, a configuration is adopted in which print processing is started after rasterization processing has been completed for PDL data of all pages in a document in advance. However, such a standby time is so-called downtime, which is a factor causing a reduction in productivity depending on the user.

Accordingly, in the printing apparatus 1 according to the present embodiment, the rasterization time required for the PDL data of each page in the document is predicted in advance, and a printing plan of the print data of the document is generated based on the rasterization time required for the PDL data of each page. For example, the controller 10 starts the print processing of the document at an intermediate stage before the rasterization processing of the PDL data of each page in the document is completed, in consideration of the total time of the rasterization time required thereafter.

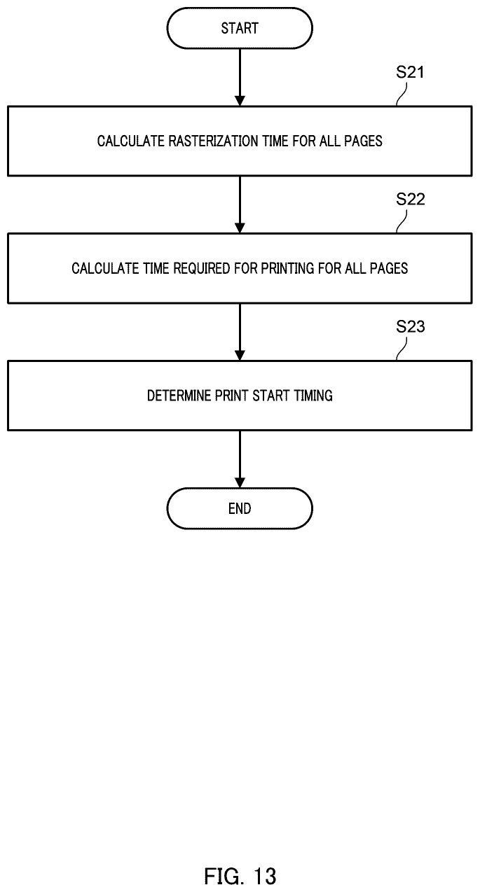

FIG. 13 is a diagram illustrating an example of printing plan generation processing by the controller 10 according to the present embodiment.

First, the controller 10 calculates the printing start timings of the respective pages based on the conveyance speed of the roll paper P (S21). Next, the controller 10 arranges the predicted values of the rasterization times of the respective pages in the document in order from the first page to the N-th page (the final page), and calculates the rasterization end timings of the respective pages (S22). Next, the controller 10 arranges the print start timings of the respective pages and the rasterization end timings of the respective pages on the same time axis. Then, the controller 10 determines the print start timing (that is, the standby time) with respect to the rasterization start timing such that the rasterization end timings of the respective pages are not delayed from the print start timings of the respective pages (S23).

At the time of actual printing, the printing plan generated by such processing is utilized to start the print processing of the document at an intermediate stage before the rasterization processing of the PDL data of all the pages in the document is completed. At this time, the controller 10 waits for the elapse of the standby time calculated in S23 after the start of the actual rasterization processing, and then sequentially executes the print processing.

As described above, according to the printing apparatus 1 according to the present embodiment, it is possible to achieve an improved productivity while preventing a situation in which a blank region occurs on roll paper on which printing has been already performed.

### Variation

Note that, the printing apparatus 1 according to the present embodiment is capable of utilizing the predicted value of the rasterization time in various forms for the generation processing of the print data of the document. For example, printing apparatuses in recent years reduce the time required for rasterization processing by performing the rasterization processing in parallel by using multiple cores and realizes an increased speed of the print processing time. See, for example, Japanese Patent Application Laid-Open No. 2018-122463.

However, even in such a printing apparatus, in a case where an image requiring a long time for rasterization processing exists in the middle, the time for rasterizing the image becomes a bottleneck, which can still be a factor of causing a standby time in print processing.

In such an image forming apparatus, an improved efficiency of the print processing time can be achieved by optimizing pages to be allocated to the respective cores based on the predicted rasterization time.

Although embodiments of the present invention have been described and illustrated in detail, the disclosed embodiments are made for purpose of illustration and example only and not limitation. The scope of the present invention should be interpreted by terms of the appended claims.

### INDUSTRIAL APPLICABILITY

According to the printing apparatus of the present invention, it is possible to predict the processing time of the rasterization processing with high accuracy.

What is claimed is:

1. A printing apparatus, comprising a hardware processor that functions as a controller that generates bitmap data by performing rasterization processing on PDL data to be printed when a print job is executed, wherein:
the controller performs, before executing the print job, the rasterization processing on a provisional basis on the PDL data at a second resolution lower than a first resolution used in actual printing, and
the controller predicts a rasterization time during the actual printing based on a processing time taken in the rasterization processing on the provisional basis, a magnification relationship between the first resolution and the second resolution, and configuration information of each object existing in the PDL data.

2. The printing apparatus according to claim 1, wherein
the configuration information of the each object includes a total number of pixels of image data existing in the PDL data, the configuration information of the each object being referred to by the controller when the controller predicts the rasterization time.

3. The printing apparatus according to claim 1, wherein
the configuration information of the each object includes a total number of pixels of image data existing in the PDL data, a total number of graphics defined by graphics data, and a total number of texts defined by text data, the configuration information of the each object being referred to by the controller when the controller predicts the rasterization time.

4. The printing apparatus according to claim 1, wherein
the controller sets, based on the configuration information of the each object existing in the PDL data, a value of the second resolution when the controller performs the rasterization processing on the provisional basis.

5. The printing apparatus according to claim 1, wherein
in a case where image correction setting is selected in job setting of the print job, the controller predicts the rasterization time based on the processing time taken in the rasterization processing on the provisional basis, the magnification relationship between the first resolution and the second resolution, the configuration information of the each object existing in the PDL data, and a content of the image correction setting.

6. The printing apparatus according to claim 1, wherein
the controller performs the rasterization processing on the provisional basis on the PDL data in units of pages, and predicts the rasterization time in the units of the pages based on the processing time taken in the rasterization processing on the provisional basis, the magnification relationship between the first resolution and the second resolution, and the configuration information of the each object existing in the PDL data for one page.

7. The printing apparatus according to claim 6, wherein
the controller calculates the rasterization time for an entire document to be printed of the print job based on the rasterization time of the PDL data of each of the pages.

8. The printing apparatus according to claim 6, wherein
the controller calculates, based on the rasterization time of the PDL data of each of the pages, a printing plan when the print job is executed.

9. The printing apparatus according to claim 1, which is applied to a roll printing machine.

10. A printing method by a printing apparatus that generates bitmap data by performing rasterization processing on PDL data to be printed and executes printing based on the bitmap data when a print job is executed, the printing method comprising:
performing, before executing the print job, the rasterization processing on a provisional basis on the PDL data at a second resolution lower than a first resolution at which actual print processing is executed, and
predicting a rasterization time during actual printing based on a processing time taken in the rasterization processing on the provisional basis, a magnification relationship between the first resolution and the second resolution, and configuration information of each object existing in the PDL data.

11. A non-transitory computer-readable recording medium storing a printing program for a printing apparatus that generates bitmap data by performing rasterization processing on PDL data to be printed and executes printing based on the bitmap data when a print job is executed, the printing program causing the printing apparatus to execute:
performing, before executing the print job, the rasterization processing on a provisional basis on the PDL data at a second resolution lower than a first resolution at which actual print processing is executed, and
predicting a rasterization time during actual printing based on a processing time taken in the rasterization processing on the provisional basis, a magnification relationship between the first resolution and the second resolution, and configuration information of each object existing in the PDL data.
